(19) United States
(12) Patent Application Publication
(10) Pub. No.: US 2010/0239994 A1
(43) Pub. Date: Sep. 23, 2010

(54) ANCHORING DEVICE FOR TOOTH AND/OR JAW ADJUSTMENT

(76) Inventor: Edwin Schmid, Gunningen (DE)

Correspondence Address: COLLARD & ROE, P.C., 1077 NORTHERN BOULEVARD, ROSLYN, NY, 11576, US

(21) Appl. No.: 12/734,914

(22) PCT Filed: Nov. 28, 2008
(86) PCT No.: PCT/EP2008/066455

§ 371 Date: Jun. 2, 2010

(30) Foreign Application Priority Data
Dec. 3, 2007 (DE) 10 2007 058 108.6

(51) Int. Cl. A61C 8/00; A61C 7/00; A61C 7/14

(52) U.S. Cl. 433/8; 433/2; 433/173; 433/174

(57) ABSTRACT

The present invention relates to an anchoring device for regulating teeth and/or jaw, having an anchoring element (1) comprising a shank (2) for arranging in a jaw bone or a tooth, and a head (3), whereon a cap (10) for arranging at least one jaw orthopedic and/or dental aid is releasably disposed, wherein the cap is constructed, in at least two parts, of a fastening element (12) for releasably fastening the cap in the head, and a mounting element (11) for mounting at least one jaw orthopedic and/or dental aid, and wherein the mounting element is freely displaceable relative to the fastening element in at least one degree of freedom of motion at least within certain limits.

### BACKGROUND OF THE INVENTION

1. Field of the Invention

The present invention relates to an anchoring device for tooth and/or jaw adjustment, having an anchoring element that has a shaft for placement in a jaw bone or in a tooth, and a head part on which a cap for placement of at least one orthodontic and/or dental technology aid is releasably disposed.

2. State of the Art

From the state of the art, screw arrangements for orthodontic treatment are known, such as those described in the German utility model DE 20 2004 011 182 U1. Such screw arrangements have an anchoring element in the form of a bone screw or the like, in which, in turn, a cap for placement of orthodontic aids is provided, by means of a screw arrangement.

Aside from placement of the cap in the anchoring element by way of a screw connection, plug-in connections are also described. Holders are provided on the cap, by means of which corresponding aids, such as tensioning wires, springs, and the like can be placed.

Similar devices are described in DE 20 2005 010 584 U1, DE 196 22 668 A1, DE 600 23 253 T2, WO 96/19946, and DE 43 43 988 A1.

By means of the two-part construction of a corresponding anchoring device, the cap can be replaced as desired, so that a plurality of different caps can be used with one anchoring element. Also, if an anchoring element is already implanted in the patient, the cap can be exchanged subsequently, so that a different cap can be selected, depending on the progress of therapy.

However, it is a disadvantage of the anchoring devices according to the state of the art that the anchoring devices described there cannot be attached at the same time, with sufficient strength, and oriented in suitable manner. In the case of plug-in connections of the cap with the anchoring element, the security of the connection is problematical, since the plug-in cap could come loose easily. Furthermore, there is the problem that for correct orientation of the cap, the anchoring element must be oriented accordingly, since otherwise, no further adjustment is possible in the case of the plug-in connection.

The same problem occurs in the case of screw connections, whereby here, the problem of orientation is even greater. While it is true that a more secure and firm connection can be achieved with a screw connection, it is difficult to foresee in what position of the cap the end stop of the thread has been reached. In this regard, it is also difficult to orient the anchoring element in such a way that the cap is oriented in accordance with its purpose of use.

### DISCLOSURE OF THE INVENTION

### Task of the Invention

It is therefore the task of the present invention to provide an anchoring device that is supposed to allow the most precise possible orientation of the anchoring device with regard to the orthodontic and/or dental technology aides that interact with it, with simultaneous secure placement of the components of the anchoring device. Furthermore, the anchoring device is supposed to be easy to produce and simple to use.

### Technical Solution

This task is accomplished by means of an anchoring device having the characteristics of claim 1. Advantageous embodiments are the object of the dependent claims. Furthermore, a connecting plate having the characteristics of claim 16 and a regulation system for regulation of tooth and/or jaw adjustments, having one or more anchoring devices and/or connecting plates according to claim 18 are proposed. Further embodiments are the object of dependent claims here, also.

The invention proceeds from the recognition that the cap is structured in at least two parts, in order to provide an attachment element for attachment of the cap on the anchoring element, on the one hand, and a holding element for holding orthodontic and/or dental technology aids, on the other hand. Furthermore, it is proposed that the holding element can move freely, relative to the attachment element, in at least one degree of freedom of motion, at least within specific limits. With this, the result is achieved that independence of the attachment of the cap in an anchoring element from the orientation of the holding element relative to interacting components is made possible. For example, the attachment element can be configured as a screw having a shaft with an outside thread, which thread can engage into a corresponding recess, with an inside thread, of the anchoring element. The holding element can be disposed on the attachment element in such a manner that it is fully free in one degree of freedom of motion, for example with regard to a rotation about the longitudinal axis, so that the holding element can be rotated, with complete freedom, about the common longitudinal axis, with reference to the attachment element. When the attachment element is screwed into the anchoring element, the holding element can therefore be held in any desired position of rotation.

Alternatively or additionally, limited mobility with regard to displaceability along the longitudinal axis can exist.

This can be achieved, for example, in that the attachment element has a connecting element that can be configured as a cylinder-type screw head, in the form of a disk, which head in turn is accommodated in a cylinder-tube-type sleeve part of the holding element, so as to rotate. Displacement along the longitudinal axis is possible with a corresponding adaptation of the height of the sleeve part and of the connecting element, in other words of the disk-shaped screw head of the attachment element.

The anchoring element can have a locking device that interacts with the cap in such a manner that the holding element is locked, i.e. fixed in place with regard to its mobility in the at least one degree of freedom of motion. This means that the locking device of the anchoring element can restrict the cap in its free rotational movement, when or after the cap is set onto the anchoring element, and precisely align it.

For example, a corresponding locking device can be formed by a pipe socket that projects from a head part of the anchoring element, the outside shape of which is configured in such a manner that a shape-fit connection with the holding element of the cap is possible. This can be achieved, for example, in simple manner, in that the pipe socket has a hexagonal, octagonal, or dodecagonal, or, in general, polygonal outside shape, in cross-section, which is complementary to the inside shape of a recess in the holding element. Accordingly, such a recess can form a fixation element that can interact with the locking element of the anchoring element.

Attachment of the attachment element to the anchoring element can take place in such a manner that the threaded shaft of the attachment element engages into a threaded bore that is provided as an extension of the pipe socket in the head part of the anchoring element.

Using such a device, it is possible to attach a cap to an anchoring element, such as a bone screw, for example, by way of a screw connection, without the holding element of the cap, which element is attached to the anchoring element by means of the attachment element of the cap, being fixed in place in its position by the screw connection. Instead, the holding element can move freely relative to the attachment element, at least in one degree of freedom of motion, as long as the locking device and the fixation element are not interacting. In the preferred embodiment variant, the free motion results from rotation about the longitudinal axis.

The position of the holding element can be fixed in place by means of the engagement of a locking device in the form of a projecting pipe socket into a recess of the holding element that acts as a fixation element. Thus, precise orientation and locking are possible. Locking of the holding element after complete production of the screw connection between attachment element and anchoring element can be unchangeably fixed in place by means of a suitable selection of the longitudinal displaceability of the holding element with regard to the attachment element. At the same time, an axial displacement of the holding element, when the connection between the attachment element of the cap and the anchoring element has been only partly produced, can lead to the result that a rotation about the longitudinal axis, and thus alignment of the holding element in the rotational position, is possible. Alternatively, it can be provided that the lock can be released even when the attachment element is completely attached in the anchoring element.

The anchoring element can be a screw, particularly a bone screw, and, in particular, can demonstrate self-tapping and/or self-locking effects. Corresponding engagement and/or action possibilities for a screw tool can be provided on the anchoring element and/or the attachment element, with which the corresponding element can be screwed in or unscrewed. In the case of the anchoring element, the correspondingly configured pipe socket or the side surfaces of the head part can find use for this purpose, while a depression for engagement of an Allen wrench can be provided in the attachment element of the cap.

The cap can have the most varied configurations, whereby one or more holding devices for orthodontic and/or dental technology aids can be provided. Accordingly, the most varied aids, such as wires, springs, braces, spacers, etc. can be provided as aids that interact with the anchoring device. These aids can be part of a regulation system having one or more anchoring devices according to the invention, whereby in particular, two caps can be provided on a common plate, or can comprise it. This is also possible by means of separating the functions of attachment and holding by means of the attachment and holding element of the cap. Accordingly, the plate, as part of the holding element, can be held in a stable position during attachment.

In particular, a common connecting plate can be provided for at least two or more anchoring elements, which plate brings about additional stabilization of the anchoring system or regulation system. In this regard, the connecting plate can be held by the anchoring elements, in other words can be disposed between the jaw and the head part of the anchoring element, or between the head part of the anchoring element and a cap or a holding element of the anchoring device, respectively.

Accordingly, the connecting plate can have accommodation openings that are either coordinated with the shaft of the anchoring element, or with the head part or the attachment element of the cap, respectively.

In particular, of the at least two accommodation openings, one accommodation opening is configured in such a manner that the anchoring element or the attachment element of the cap can be accommodated in variable manner with regard to its position, so that at least one degree of freedom of motion exists in one spatial direction. This can be achieved, for example, in that the accommodation opening is configured as an oblong hole.

In particular, one accommodation opening can be configured in such a manner that it precisely determines the position of the anchoring element or the attachment element of the cap, respectively, while the second or further accommodation openings are configured for position-variable accommodation of the anchoring element or of the attachment element of the cap, respectively.

Aside from the function of connecting multiple anchoring devices, the connecting plate can take on additional functions with regard to placement of aids such as wires or holding elements such as braces and the like.

### BRIEF DESCRIPTION OF THE FIGURES

Additional advantages, features, and characteristics of the present invention will become clear from the following detailed description of exemplary embodiments, using the attached drawings. In this connection, the drawings show, in purely schematic manner, in

FIG. 1 a side view of an anchoring element in the form of a bone screw;

FIG. 2 a side view of the bone screw from FIG. 1;

FIG. 3 a top view of the bone screw from FIGS. 1 and 2;

FIG. 4 a side view of a first embodiment of a cap for the bone screw from FIGS. 1 to 3;

FIG. 5 a sectional view through the cap from FIG. 4;

FIG. 6 a top view of the cap from FIGS. 4 and 5;

FIG. 7 a second exemplary embodiment of a cap, according to the invention, for the bone screw from FIGS. 1 to 3;

FIG. 8 a sectional view through the cap from FIG. 7;

FIG. 9 a top view of the cap from FIGS. 7 and 8;

FIG. 10 a side view of a third exemplary embodiment of a cap according to the invention, for use with the bone screw from FIGS. 1 to 3;

FIG. 11 a side view of the cap from FIG. 10, rotated by 90° relative to the view of FIG. 10;

FIG. 12 a sectional view through the cap from FIGS. 10 and 11, parallel to the image plane of FIG. 10, and perpendicular to the image plane of FIG. 11;

FIG. 13 side views (a, b) of another embodiment of a cap according to the invention;

FIG. 14 a top view of a jaw part with a regulation device that comprises an anchoring device according to the invention;

FIG. 15 a side view (a) and a top view (b) of a first embodiment of a connecting plate according to the invention;

FIG. 16 a top view of a second embodiment of a connecting plate according to the invention; and in

FIG. 17 a side view (a) and a top view (b) of a third embodiment of a connecting plate according to the invention.

FIG. 1, in a side view, shows an anchoring element in the form of a bone screw 1, which has a head part 3 and a shaft 2 having a thread 5. The shaft 2 with the thread 5 is intended to be anchored in a jaw bone of a patient.

The head part 3 is formed by a conical stump that narrows conically opposite the shaft 2, which stump has a square base shape with rounded-off edges in cross-section (see FIG. 3). Accordingly, the side surfaces of the head part 3 can serve for engagement of a screw tool, such as a wrench.

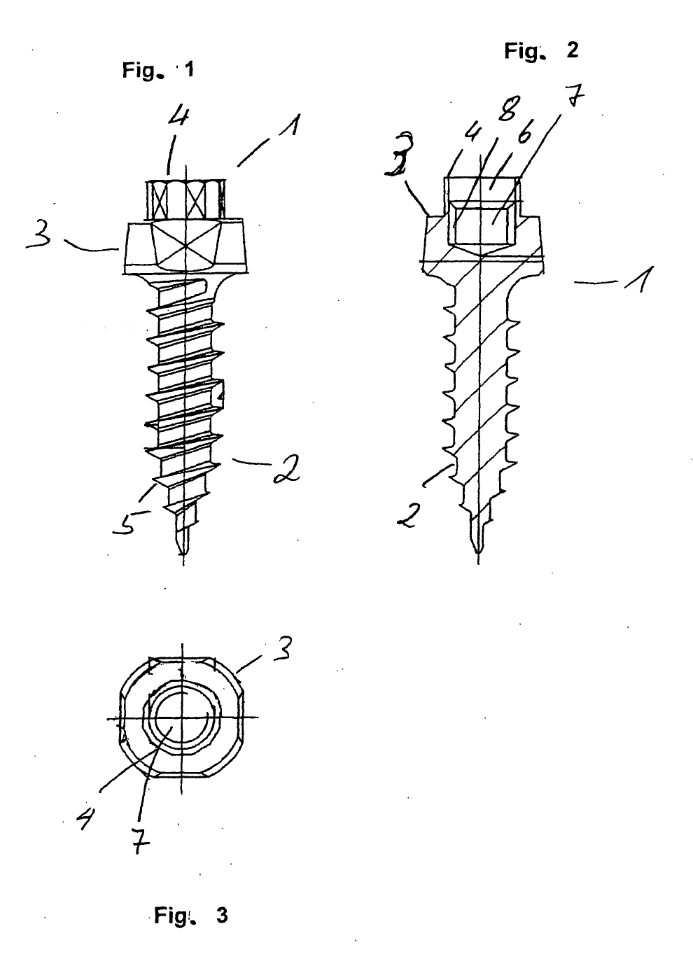

On the side of the head part 3 that lies opposite the shaft 2, a pipe socket 4 is provided, which has a dodecagonal cross-sectional shape on the outside, as can be seen in FIGS. 1 and 3. The inside wall of the pipe socket 4, in contrast, is configured cylindrically, so that a cylindrical cavity 6 results, as shown in FIG. 2.

The cylindrical cavity 6 has an inside thread 8 in its lower region 7, which region is continued into the conical stump body of the head part 3.

The inside thread 8 serves for attachment of a cap 10, by way of an outside thread 13, which thread is provided in an attachment element 12 of the cap 10 (see FIG. 5).

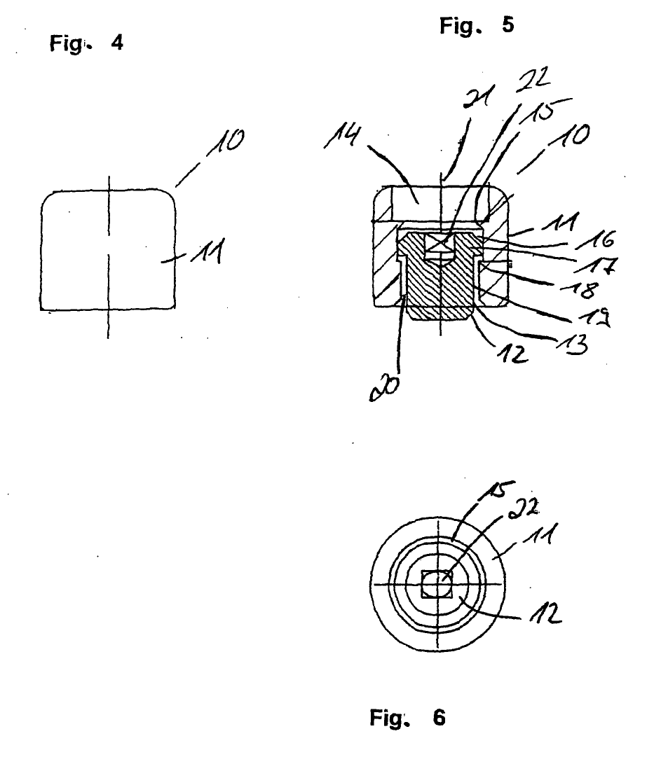

An example for the cap 10 is shown in FIGS. 4 to 6. In the side view of FIG. 4 and the top view of FIG. 6, it can be seen that the cap 10 comprises a cylinder-type pipe body that is referred to as a holding element 11.

The interior of the cylinder-pipe-type body 11 is formed by a recess 19 at one end of the cylinder-pipe-type body 11 and a passage opening 14 at the other end of the cylinder-pipe-type body 11, which enclose a cylinder-pipe-type sleeve 16 between them. The connecting element 17 of the attachment element 12 is held in the cylinder-pipe-type sleeve 16, which has a greater diameter compared with the recess 19, and thus is separated from the recess 19 by a shoulder 18. The connecting element 17 has a cylinder-type disk that is mounted in the cylinder-pipe-type sleeve 16, so as to rotate. In the direction of the recess 19, motion is limited by the shoulder 18, since the diameter of the cylinder-type disk 17 is greater than the inside diameter of the recess 19.

In the direction of the passage opening 14, motion of the attachment element 12 and of the cylinder-shaped disk 17 is limited by a knurled edge 15 that is bent downward from the passage opening 14 after the attachment element 12 has been set into the cylinder-pipe-type body 11 or the holding element 11. The knurled edge 15 and the connecting element 17 have slanted surfaces, not indicated in greater detail, for reciprocal contact.

By means of the configuration of the cylinder-pipe-type sleeve 16, the disk-shaped connecting element 17 of the attachment element 12 can move within specific limits along the longitudinal axis 21 of the cap 10, and can perform unhindered rotation about the longitudinal axis 21.

The attachment element 12 has not only the connecting element 17 but also a shaft 13 with an outside thread, which essentially comes to lie in the region of the recess 19 of the holding element 11. A space is provided between the shaft 13 and the inside of the holding element 11, in the region of the recess 19, so that a circumferential ring gap 20 is formed.

When the attachment element 12 is screwed into the threaded region 7 of the pipe socket 4 of the bone screw 1 with the shaft 13, the pipe socket 4 engages into the ring gap 20. Because of the outside contour of the pipe socket 4, with a dodecagonal cross-section, which corresponds to the inside shape of the recess 19 of the holding element 11, the position of the holding element 11 relative to the anchoring element 1, with regard to rotation about the longitudinal axis 21 of the cap 10, is locked, so that no rotation of the holding element 11 about the longitudinal axis 21 can take place. As a result, the rotational orientation of the holding element 11 during attachment of the cap 10 in the anchoring element 1, by way of the attachment element 12, is rotationally stable. Accordingly, the holding element 11 can be aligned in the desired position, for example with reference to corresponding aids, without any change in position occurring as the result of attachment of the cap 10 on the anchoring element 1, by means of the attachment element 12.

The axial displaceability can be set in such a manner, by means of a corresponding configuration of the height of the pipe-type cylindrical sleeve 16 and of the disk-shaped connecting element 17, that the holding element 11 can be released when the attachment element 12 is already partly screwed in, by raising it from the engagement of the pipe socket 4 of the anchoring element 1, and brought into a desired rotational position. In this way, it is possible to make a change in the position of the holding element 11 after a preliminary placement of the cap 10.

In order to attach the attachment element 12 in the threaded region 7 of the anchoring element 1, a depression 22 for engagement of a screw tool, for example an Allen wrench, is provided on the side of the connecting element 17 that lies opposite the shaft 13. In this connection, the screw tool can be passed through the passage opening 14 of the holding element 11.

FIG. 6, in a top view, shows the corresponding engagement opening 22 of the attachment element 12.

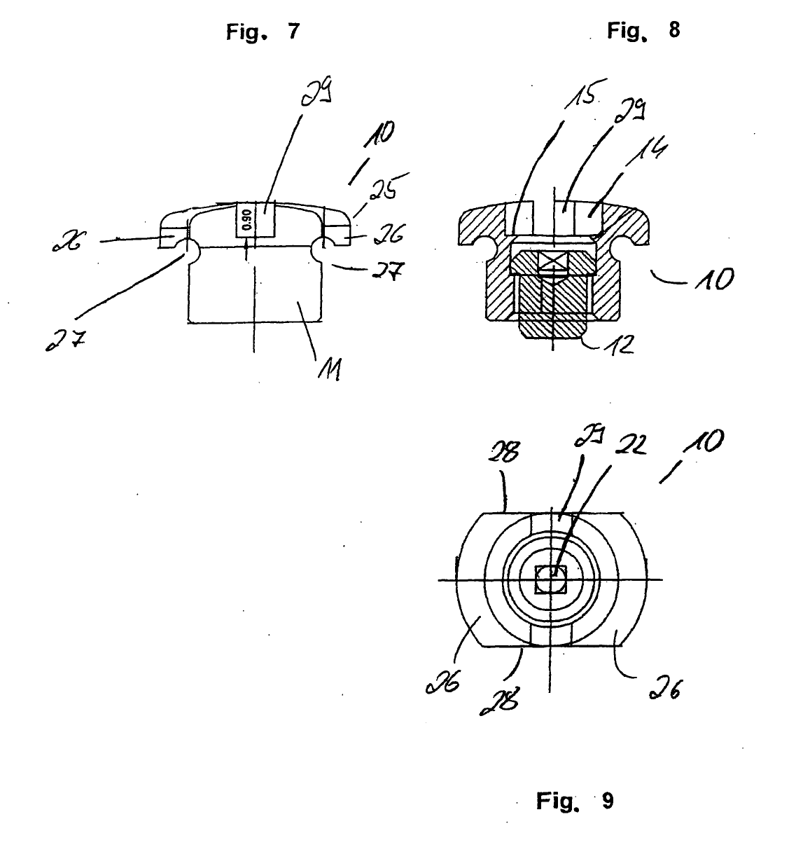

FIGS. 7 to 12 show further exemplary embodiments of a corresponding cap 10, as it can be used with the anchoring element 1. Accordingly, identical reference symbols are used for the cap 10, where the components are identical. For these components, reference is made to the description of the exemplary embodiment of FIGS. 4 to 6, in order to avoid unnecessary repetition. Essentially, the exemplary embodiments of FIGS. 7 to 12 are described with regard to their differences from the embodiment of FIGS. 4 to 6.

The cap 10, which is shown, in FIGS. 7 to 9, in a side view (FIG. 7), in a sectional view (FIG. 8), and in a top view (FIG. 9), differs from the embodiment of FIGS. 4 to 6 first of all, in that the holding element 11, in the form of a cylinder-pipe-type body, has a lid part 25 on the side that lies opposite the side for attachment on the anchoring element 1, on which part projecting holding devices 26, 27 are provided. The holding devices are configured as projections 26 in the form of shoulders, which project away on two opposite side of the cylinder-pipe-type body 11, as well as recesses 27 that interact with them and are arc-shaped in cross-section, into which wires or the like, for example, of a tensioning device can be laid.

The projections follow the cylinder-type base shape of the holding element 11 as concentric partial rings, whereby two flattened regions or cutting edges 28 that lie opposite one another are provided, as can be seen in FIG. 9.

The lid element 25 of the holding element 11 of the cap 10 of FIGS. 7 to 9 furthermore has a groove 29 that extends over the entire cross-section of the holding element 11, and can serve for engagement of a tool, particularly a screw tool, or for placement of an orthodontic and/or dental technology aid. Furthermore, in the case of this embodiment, as well, the cylindrical passage opening 14 is provided, which serves for inserting the attachment element 12, on the one hand, and also can be used for placement of corresponding aids, for example by wedging them in place, on the other hand.

For the remainder, the cap 10 of the embodiment as shown in FIGS. 7 to 9 corresponds to the embodiment of FIGS. 4 to 6 with regard to the placement of the attachment element 12, so that a repeated description is unnecessary.

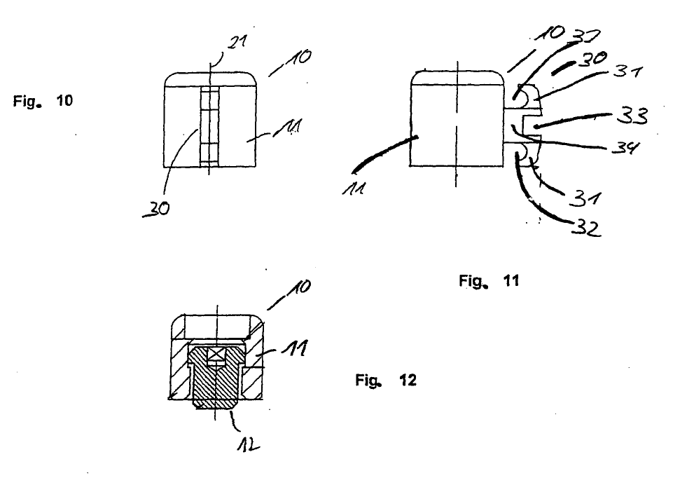

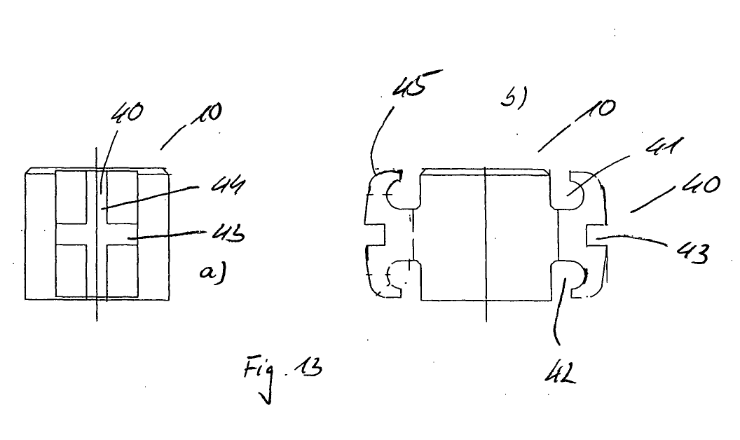

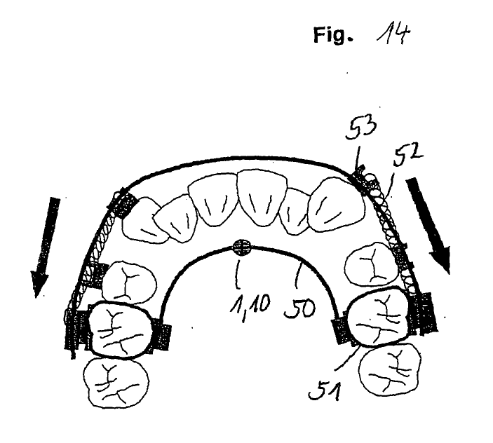

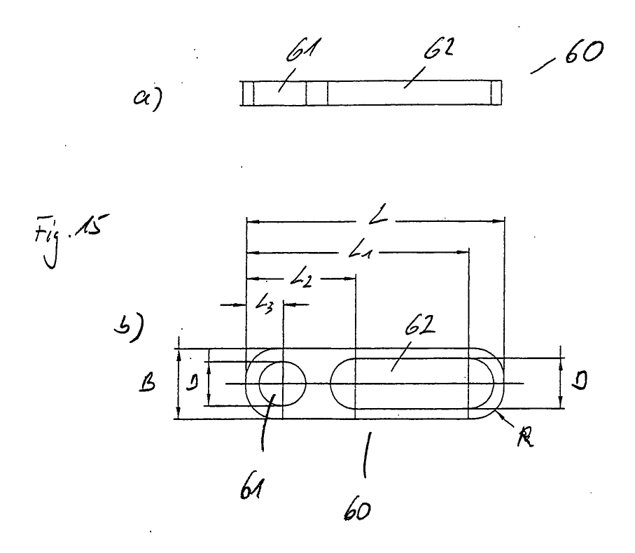

FIGS. 10 to 12 show another embodiment of a cap 10, specifically in the two side views of FIGS. 10 and 11, which are rotated by 90° relative to one another, in each instance, as well as the sectional view of FIG. 12, which is drawn in a plane parallel to the image plane of FIG. 10 and perpendicular to the image plane of FIG. 11.

The embodiment of FIGS. 10 to 12 differs from the preceding embodiments in that a laterally disposed holding device 30 in the form of a side arm ([in English:] bracket) is provided.

The side arm 30 comprises two crosspieces 31 that extend symmetrically from a holding arm 34, in order to define accommodation spaces 32 for wires, tensioning elements, and the like between the outer wall of the holding element 11 and the crosspieces 31.

Furthermore, a rectangular groove 33, similar to the groove 29 in the embodiment of FIGS. 7 to 9, is provided between the crosspieces 31, in the region of the holding arm 34.

Aside from the caps 10 as described, with different holding devices 14, 29, 26, 27, 30, other caps with similar or different holding devices are possible.

In FIG. 13, in the side views of the figure parts a) and b), a cap 10 is shown, which has two holding devices 40 and 45 that lie opposite one another and are configured similar to the holding device 30 of the embodiment as shown in FIG. 11. Here again, corresponding accommodation spaces 41, 42 for wires as well as a corresponding groove 43 are provided. However, the holding device 40, as compared with the holding device 30 of the embodiment from FIG. 11 or FIG. 10, respectively, is configured to be correspondingly wider, and, in addition to the groove 33, which corresponds to the groove 43, a groove 44 that runs crosswise to the groove 43 is provided, as is particularly evident from the figure part a) of FIG. 13. This shows that many different variation possibilities for holding devices exist.

In particular, it is possible to provide a common cap or a common holding element, for example in the form of a plate or the like, for multiple anchoring elements, as will still be described below. Furthermore, caps for the working process, for example caps as a cover during production of an impression, are possible. By means of the configuration of the anchoring device with the anchoring element 1 and the cap 10, which is secured to prevent rotation, it is possible to attach different caps, such as the plate-shaped common cap, for example, or other types of caps that must be stable in their position, using the corresponding anchoring device.

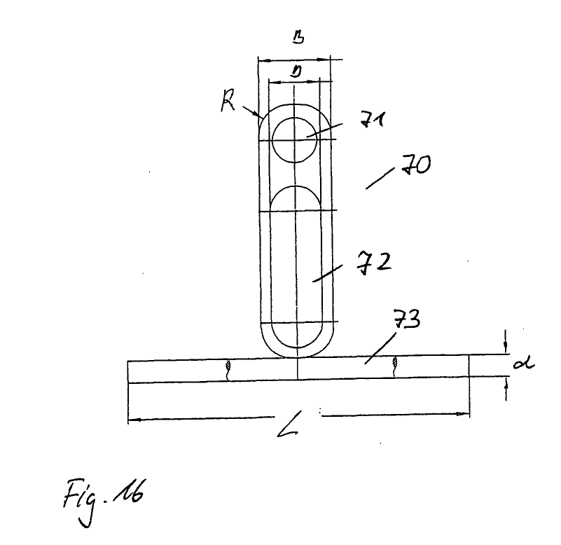

An example for the use of the anchoring device according to the invention is shown in FIG. 14.

FIG. 14 shows a top view of a lower or upper jaw, in which the incorrect position of teeth is being treated by means of a regulation device that comprises an anchoring device 1, 10 according to the present invention. The anchoring device 1, 10 is anchored in the jaw bone and serves to accommodate tensioning wires 50 that are attached to the teeth by way of braces 51 or other suitable attachment means 53, and press them in a specific direction (see arrows) by means of exerting tensioning force. Instead of wires 50, spring elements 52 can also be provided, in order to apply additional force for regulating the incorrect position of the teeth.

The following method of procedure can be used to place such a regulation device. First, one or more anchoring devices 1, 10 according to the present invention are fixed in place in the jaw. The anchoring device has the anchoring element as well as an impression cap provided as a cap. In this constellation, an impression is produced that shows the precise position of the jaw, the teeth, and the anchoring device. Accordingly, a positive can be formed again from the negative, into which the corresponding regulation device can be inserted and adapted. This can be done in the laboratory, using the model. After completion of the regulation device, the corresponding components can be placed on the anchoring element that is situated in the patient's jaw.

FIG. 15 shows, in the figure parts a) (side view) and b) (top view), a first embodiment of a connecting plate 60 that has two accommodation openings 61 and 62 for accommodating the locking device of the anchoring element or of the attachment element of a cap that is to be disposed on top of it. The accommodation opening 61 is configured as a circular opening having the diameter D, while the accommodation opening 62 is structured as an oblong hole, so that the anchoring element or attachment element to be accommodated accordingly is displaceable along the longitudinal axis of the connecting plate 60 or the oblong hole, respectively, and thus the position can be selected in variable manner.

The dimensions L, L₁, L₂, L₃ indicate different lengths of the connecting plate 60, while B refers to the width of the connecting plate, and R stands for the radius of the rounded-off edges. These designations are also used in identical manner in the subsequent embodiment.

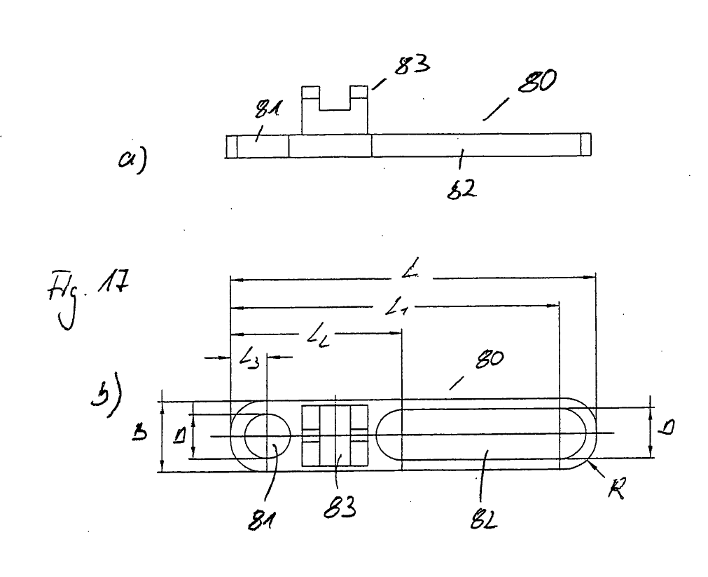

FIG. 16 shows a connecting plate 70, which has not only a first accommodation opening 71 and a second accommodation opening 72, but also a wire 73, disposed in fixed manner, on a face of the connecting plate 70. The wire 73 can have a length L and a thickness d that can be selected in accordance with the requirements. Here again, the first accommodation element 71 is configured for the anchoring element or attachment element of the cap to be accommodated, in such a manner that the position is clearly fixed in place, while the second accommodation opening 72, as an oblong hole, allows variable placement of the anchoring element or attachment element.

The connecting plate 80 that is shown in FIG. 17, in a side view in figure part a) and in a top view in figure part b), also has two accommodation openings 81 and 82, one of which is configured as an oblong hole, similar to the preceding embodiments of the connecting plates 60 and 70. In addition, the connecting plate 80 comprises a brace 83 that can serve as an attachment or holding means for wires and the like.

Although the present invention has been described in detail using the exemplary embodiments, it is obvious to a person skilled in the art that the invention is not restricted to these exemplary embodiments, but rather, changes, additions, and modifications can be made, in such a manner that individual characteristics can be left out or combined with one another in different ways, without bringing about the scope of protection of the attached claims. In particular, a combination of all the individual characteristics of the exemplary embodiments that have been presented can be undertaken.

1. Anchoring device for tooth and/or jaw adjustment, having an anchoring element (1) that has a shaft (2) for placement in a jaw bone or in a tooth, and a head part (3) on which a cap (10) for placement of at least one orthodontic and/or dental technology aid is releasably disposed, wherein
the cap is structured in at least two parts, from an attachment element (12) for releasable attachment of the cap in the head part, and a holding element (11) for holding at least one orthodontic and/or dental technology aid, whereby the holding element can move freely, relative to the attachment element, in at least one degree of freedom of motion, at least within specific limits.

2. Anchoring device according to claim 1, wherein
the attachment element (12) has a shaft (13) with an outside thread that can be screwed into an inside thread (8) in the head part of the anchoring element.

3. Anchoring device according to claim 1, wherein
the holding element (11) can be moved completely freely relative to the attachment element (12), in one degree of freedom of motion.

4. Anchoring device according to claim 1, wherein
the holding element (11) can rotate freely about the longitudinal axis (21) of the attachment element (12) or an axis parallel to the shaft axis or longitudinal axis of the anchoring element, particularly freely by 360°, and/or can be freely displaced along the longitudinal axis of the attachment element or an axis parallel to the shaft axis or longitudinal axis of the anchoring element, within specific limits.

5. Anchoring device according to claim 1, wherein
the anchoring element (1) has a locking device (4) that interacts with the cap in such a manner that the holding element is locked in place with regard to its mobility in the at least one degree of freedom of motion.

6. Anchoring device according to claim 5, wherein
the locking device (4) comprises a pipe socket that projects from the head part (3) on the side that lies opposite the shaft, whereby the pipe socket (4) has an outside shape that is hexagonal, octagonal, or dodecagonal or polygonal in cross-section.

7. Anchoring device according to claim 1, wherein
the holding element (11) has a fixation element (19) by means of which the holding element can be locked in place, so that the mobility of the holding element in the at least one degree of freedom of motion can be restricted.

8. Anchoring device according to claim 7, wherein
the holding element has a recess (19) on the side that faces the head part, the inside shape of which is hexagonal, octagonal, or polygonal in cross-section.

9. Anchoring device according to claim 7, wherein
the fixation element (19) of the holding element (11) interacts with the locking element (4) of the anchoring element (1).

10. Anchoring device according to claim 1, wherein
the attachment element (12) has a connecting element (17) for connecting with the holding element (11), which element is configured as a cylinder-type disk element, which is accommodated in a cylinder-pipe-type sleeve part (16) of the holding element, so as to rotate, whereby the motion along the longitudinal axis of the sleeve is limited by means of flange-like or shoulder-like projections of the sleeve, and the connecting element (17) is disposed on the shaft (13) of the attachment element (12), and the shaft of the attachment element runs in the recess of the holding element, at least in part, whereby a distance is provided between the recess wall and the shaft, in order to accommodate the pipe socket of the anchoring element.

11. Anchoring device according to claim 10, wherein
the cylinder-pipe-type sleeve (16) of the holding element (11) is provided to follow the recess.

12. Anchoring device according to claim 1, wherein
the holding element (11) has a lid part on the side that faces away from the anchoring element, which part has a passage opening to the attachment element.

13. Anchoring device according to claim 1, wherein
the holding element (11) comprises one or more holding devices (14, 26, 27, 29, 30) for orthodontic and/or dental technology aids, which are selected from the group that comprises: recesses, passages, stirrups, shoulders, wings, braces, clamps, hooks, projections, openings, bores, plates, threads, and the like and/or comprise the aids of wires, springs, braces, caps, spacers, and the like, and/or the anchoring element (1) is a screw, particularly a self-tapping and/or self-locking screw.

14. Anchoring device according to claim 1, wherein
the head part (3) of the anchoring element (1) has an engagement and/or action possibility for a screw tool and/or the attachment element (12) has an engagement possibility (22) for a screw tool, particularly an engagement in the connecting element that is accessible through the passage opening of the holding element.

15. Anchoring device according to claim 1 wherein
the cap is a lost cover cap for an impression.

16. Connecting plate for connecting at least two anchoring devices for tooth and/or jaw adjustment comprising
a plate-shaped base body having at least a first accommodation opening for accommodating a first anchoring device and at least a second accommodation opening for accommodating a second anchoring device, whereby at least one accommodation opening is configured in such a manner that the anchoring device can be placed in variable manner.

17. Connecting plate according to claim 16, wherein
the connecting plate comprises one or more holding devices (14, 26, 27, 29, 30) for orthodontic and/or dental technology aids, which are selected from the group that comprises: recesses, passages, stirrups, shoulders, wings, braces, clamps, hooks, projections, openings, bores, plates, threads, and the like, and/or aids are disposed, whereby the aids comprise wires, springs, braces, caps, spacers, and the like.

18. Regulation system for adjustment of incorrect positions of teeth and/or jaws, having one or more anchoring devices according to claim 1 and/or one or more connecting plates, each connecting plate comprising a plate-shaped base body having at least a first accommodation opening for accommodating a first anchoring device and at least a second accommodation opening for accommodating a second anchoring device, whereby at least one accommodation opening is configured in such a manner that the anchoring device can be placed in variable manner.

19. Regulation system according to claim 18, wherein
at least two caps comprise a common plate, or a common plate is provided on at least two caps.
